(19) United States
(12) Patent Application Publication
(10) Pub. No.: US 2023/0025925 A1
(43) Pub. Date: Jan. 26, 2023

(54) SLOT GAME WITH DYNAMICALLY ASSIGNED REEL STRIP LOCATIONS

(71) Applicant: Aristocrat Technologies, Inc., Las Vegas, NV (US)

(72) Inventors: Blake Davis, Las Vegas, NV (US); Allon Englman, Las Vegas, NV (US)

(21) Appl. No.: 17/710,356

(22) Filed: Mar. 31, 2022

Related U.S. Application Data
(60) Provisional application No. 63/223,848, filed on Jul. 20, 2021.

(51) Int. Cl. G07F 17/32; G07F 17/34

(52) U.S. Cl. CPC G07F 17/3262; G07F 17/3213; G07F 17/34

(57) ABSTRACT

A gaming system may provide a slot game in which multiple reel strips are “spun” in order to generate game outcomes based on the award symbols that are displayed on the reels. Different award symbols may be associated with different payout values, and different reel strips may have different sets of award symbols, leading to some reel strips having a higher potential payout than others. In some cases, some reel strips may include special symbols that have a significant impact on the potential payout, such as by cumulatively multiplying other earned awards. In order to manage game characteristics like return-to-player (“RTP”) and volatility while providing special symbols like award value multipliers, the gaming system may select from predefined sets of reel strips and position the reel strips in particular locations in a symbol matrix of the game

### CROSS-REFERENCE TO RELATED APPLICATION

This application is a nonprovisional of, and claims the benefit under 35 U.S.C. 119(e), U.S. Provisional Patent Application No. 63/223,848, filed Jul. 20, 2021, the contents of which are incorporated herein by reference as if fully disclosed herein.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

The instant application describes a “hold-and-spin” slot-type game in which the reel sets for a game instance are selected from predetermined reel sets. The predetermined reel sets specify the particular group of reel strips that are to be used in a game instance, as well as the particular row that each reel strip is assigned to. The predetermined reel sets may not include column assignments, however. Rather, the reel strips of a given row may be shuffled among the positions in that same row between spin events. The described “hold-and-spin” game may also include special award symbols, such as an award symbol that is associated with its own spin counter. If the spin counter reaches a predetermined value, such as by the player earning and using additional spins, a prize may be awarded to the player.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A-4G illustrate an example user interface sequence for a hold-and-spin style slot game.

FIGS. 5A-5B illustrate reel strip locations in a hold-and-spin game for which reel strip locations may be dynamically assigned.

FIG. 6 is a flowchart showing example operations for implementing a game in which reel strips are assigned to locations in a symbol matrix to generate random based game outcomes with special symbols.

FIG. 7 is a flowchart showing example operations for implementing a game in which reel strips are assigned to locations in a symbol matrix to generate random based game outcomes with special symbols.

### DETAILED DESCRIPTION

As noted above, slot games may display symbols in a row-by-column matrix, and specific combinations of the symbols in the matrix (e.g., along paylines) will result in the player receiving an award. The symbols are contained on reel strips, which are spun, either physically or virtually, to determine which symbols are displayed in which symbol location of the row-by-column matrix. The reel strips may be physical (e.g., a strip of paper with symbols depicted thereon and attached to a spinning reel), or virtual (e.g., data structure that defines a particular set of symbols for the reel strip). In some cases, each column or row of the row-by-column matrix may be associated with a single reel strip, such that each symbol shown in that column or row after a spin is from the same reel strip. In other cases, each symbol location in the row-by-column matrix is associated with a separate reel strip. For example, in a game with 6 rows and 5 columns, 30 reel strips may be spun to populate the symbols in each symbol location. Symbols may include static graphics, blank symbols (e.g., empty spaces with no graphics), animated graphics (in the case of virtual reel strips displayed on a video display monitor), and the like.

In some cases, slot games may include a main game and a supplementary game. In the main game, the symbols are part of reel strips that are spun, either physically or virtually, and the game outcome depends on whether specific combinations of the symbols in the matrix are positioned along predetermined paths or paylines. In the supplementary game, sometimes referred to as a “hold-and-spin” game, multiple reels in a reel matrix may be spun, and awards may be given based on the outcome of each individual reel. It will be understood that different slot games may have different combinations of game mechanics. For example, the main game may be a hold- and spin game, and the supplementary game may use paylines to determine game outcomes. In another example, both main and supplementary game are hold-and-spin style game. Other combinations are also contemplated.

In some cases, award symbols from one spin are carried over or “held” during subsequent spins (e.g., a symbol on a reel strip is locked in place for subsequent spins in the supplemental game). When all spins of the supplemental game are used, all earned awards, including those carried over or held from previous spins, are awarded to the player. In some cases, a supplementary game may be earned or purchased during gameplay of the main game. In some cases, a supplementary game as described above may be a main game of a slot game, or it may be a bonus feature of a main game.

A hold-and-spin game as described herein may include reel strips with multiple types of award symbols, including standard symbols and special symbols. Standard symbols may be assigned a credit value when earned, based on an outcome of a random number generator, as described herein. The credit value of the standard symbol may be a monetary or non-monetary credit value (e.g., a number value representing a monetary value or a number of credits), a wager multiplier (e.g., a number value representing a multiplier that is applied to a wager, such as a 2× or 3× wager multiplier), or the like. Special symbols may affect or be affected by other already-earned symbols. For example, special symbols, when earned, take on a credit value that is based on already-earned symbols (including both standard symbols and special symbols), or they may change (e.g., increase or decrease) credit values of already earned symbols. Special symbols may also have other functions, including but not limited to modifying gameplay (e.g., increasing the number of active reels in the game, changing the number of spins remaining), providing special spin-based award opportunities, and the like. Additional examples of special symbols and their functions are provided herein.

In some cases, special symbols may have a significant impact on the size of the award that can be earned. For example, one type of special symbol, which may be referred to as a cumulative symbol, may provide an award that is the sum of all of the awards that have already been earned. If a player has already earned multiple awards on multiple reel strips, an award associated with the cumulative symbol may have a very high credit value relative to the other awards. In games with multiple such special symbols, the possible payout to the player for a given game may be very high.

Described herein are techniques for providing a new and improved gaming device operation and capability in a hold-and-spin style game that generates randomly-based game outcomes with special symbols, while also managing game characteristics such as RTP and/or volatility of the game. In particular, the hold-and-spin game mechanic described herein facilitates the use of special symbols that apply credit value multipliers and credit value accumulators, which can have a significant effect on the potential payout of a game, while managing RTP and/or volatility of the game and to mitigate uncontrolled payout potential. For example, a game may include a matrix of symbol locations, each associated with a reel strip. When the game is initiated, a specific set of reel strips may be selected from a set of predefined reel strip sets. Each reel strip set includes a plurality of reel strips. Each reel strip in the selected set of reel strips is assigned to a particular row in the matrix and has a predetermined set of symbols. The row assignment for a reel strip may be specifically selected based on the symbol(s) on that reel strip. For example, reel strips with higher-value symbols (e.g., symbols with higher credit values) may be placed on rows that are initially inactive and only become active if a certain outcome is achieved during the gameplay. In some cases, there are multiple inactive rows, and a “higher” level row can only be activated after all “lower” rows are activated.

By predetermining the reel strip sets and row assignments, and more particularly by pre-assigning high-value reel strips to rows that are less frequently earned, a new and improved gaming device operation and capability may be provided while also effectively managing factors such as the RTP, volatility, and progressivity of awards (e.g., such that the value of an award is generally consistent with the frequency with which it is earned). For example, by placing a high-value symbol (which may have a large payout) on a row that is more likely to be activated (e.g., a “lower” row), the RTP of the game may be increased. By placing a high-value symbol on a row that is less likely to be activated (e.g., a “higher” row), the RTP of the game may be decreased. Additionally, by including several tiers of inactive rows (e.g., rows that require activation of lower rows before they can be activated), the RTP, volatility, and progressivity can be effectively managed with a greater number of high-value award symbols. Accordingly, a greater variety of game outcome options may be provided while effectively managing game factors such as RTP, volatility, and progressivity.

Though the reel strip sets may be predetermined and each reel strip may be initially assigned to a particular symbol location, at each spin event of the game the position of the reel strips in a row may be dynamically shuffled or randomized. The shuffling of reel strips may help avoid pattern detection by a player, as the symbols, which may be momentarily visible during reel spins, appear to move around a row of the symbol matrix rather than repeatedly appearing in the same location. By using the technique of selecting from predetermined reel strip sets, and then shuffling reel strips among a row in a symbol matrix, the RTP of a game can be effectively managed while also providing new and improved gaming device operation and capability.

In some cases, special symbols may be used to further improve gameplay operations. For example, a special symbol may be configured to award a large award (e.g., a jackpot) if the player continues to earn a predetermined number of additional free spins. This “jackpot” award may be associated with its own spin counter that counts down as the user continues to earn and initiate more spins. Once the spin counter reaches zero, the game awards the player an award associated with the special symbol. Other types of special symbols may be provided as well, as described herein.

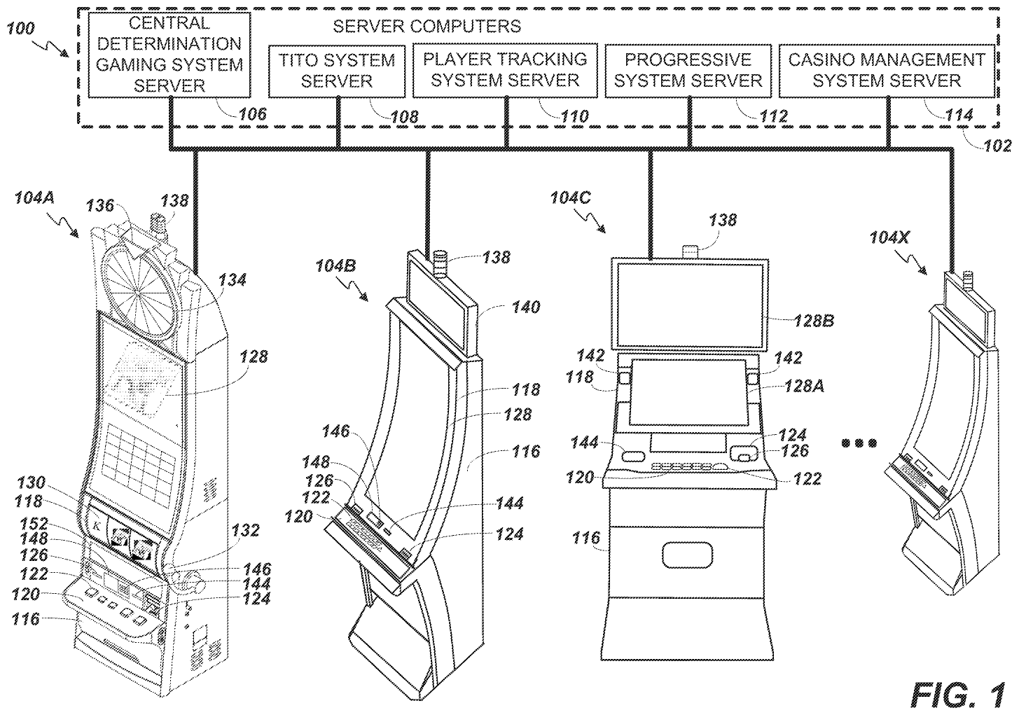

FIG. 1 illustrates several different models of EGMs which may be networked to various gaming related servers. Shown is a system 100 (e.g., a gaming system) in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

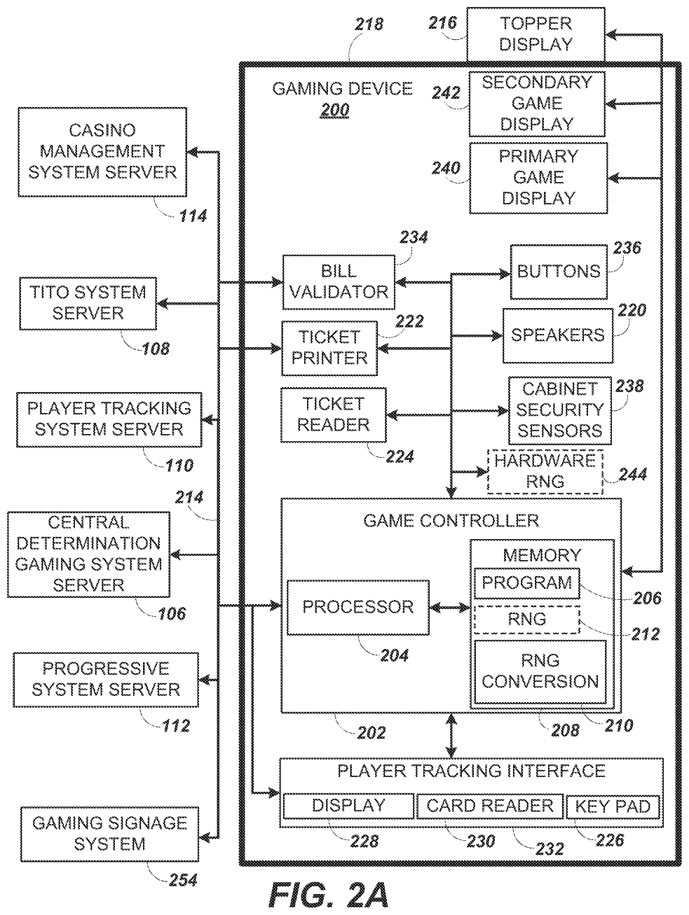

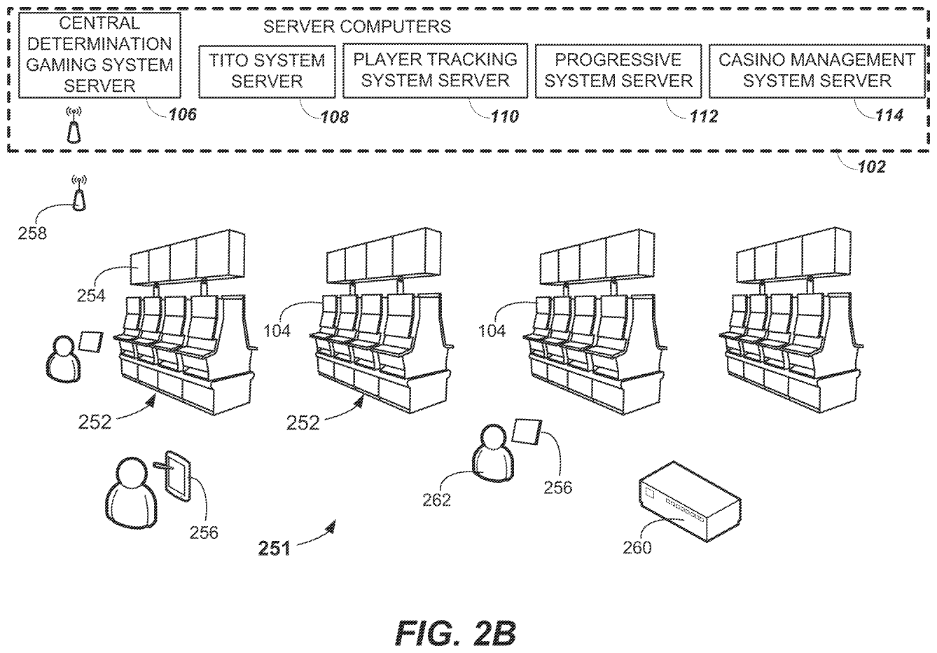

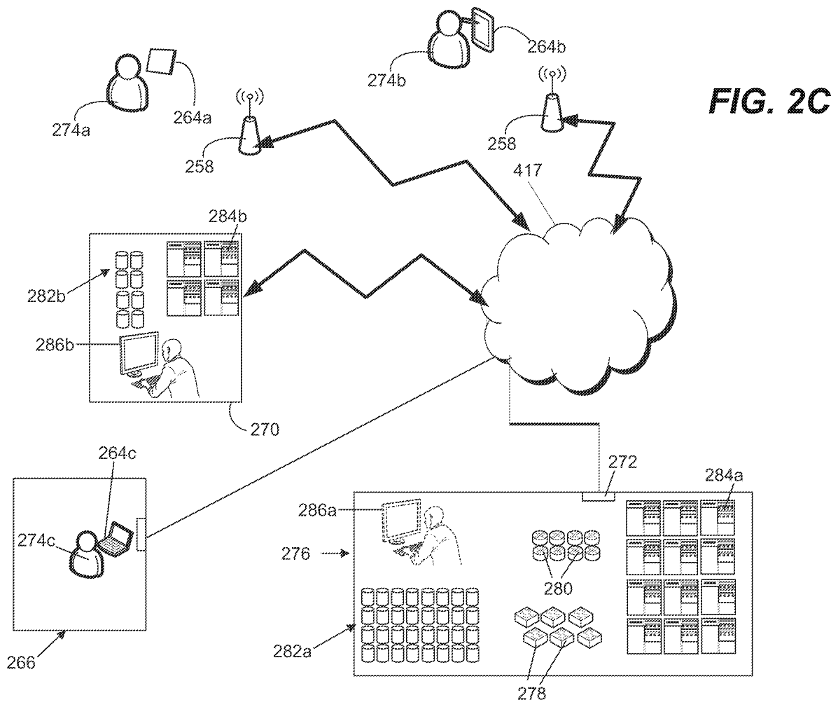

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, the “volatility” of a game refers to how large or small the potential changes in a player's credit balance are; more volatile games may have larger payouts that occur more infrequently, for example. Volatility may vary with the frequency or probability of an event such as a special mode, payout, or the like occurring. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

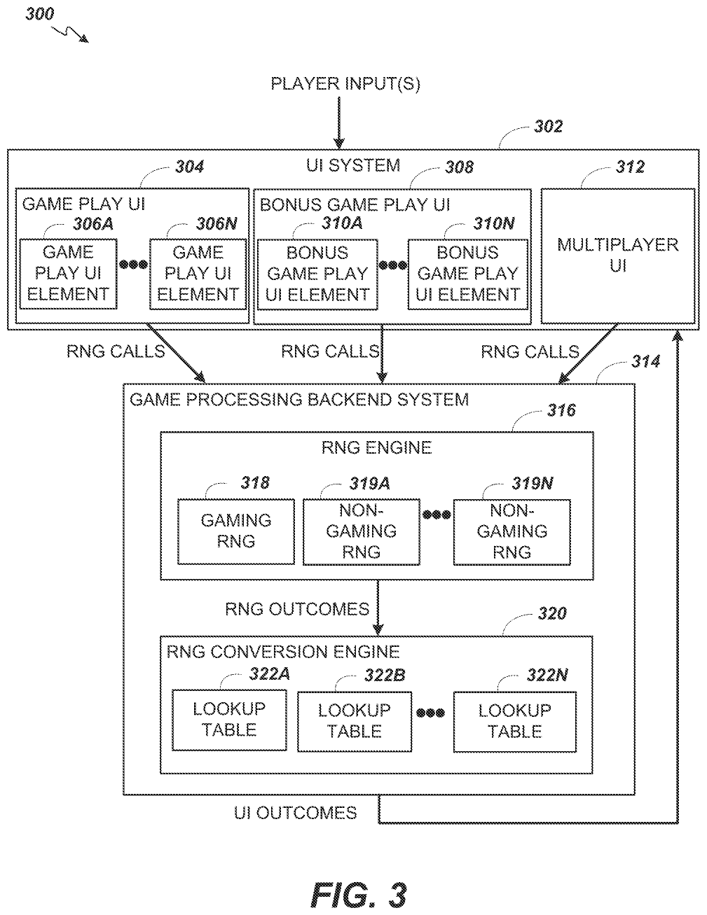

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

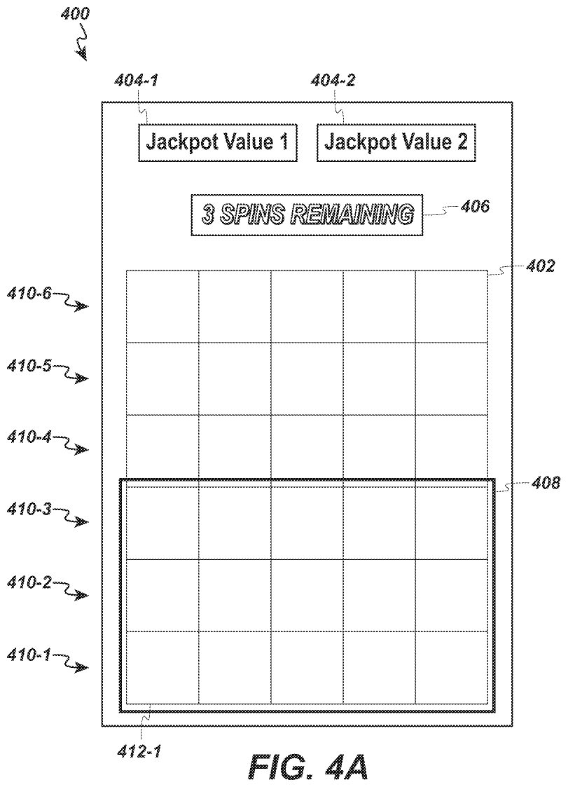

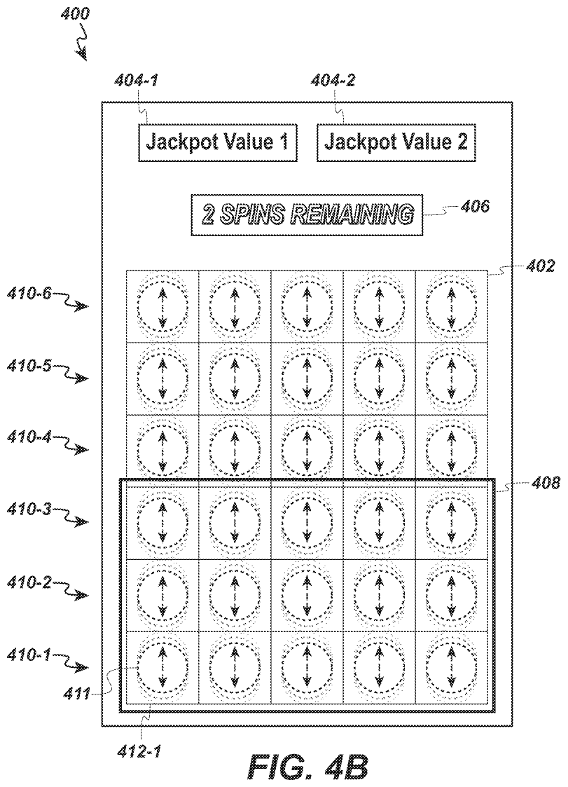

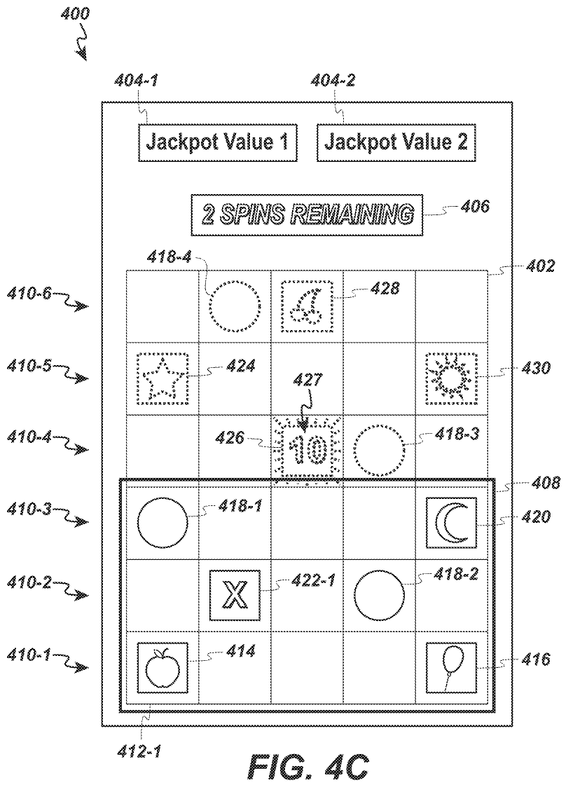

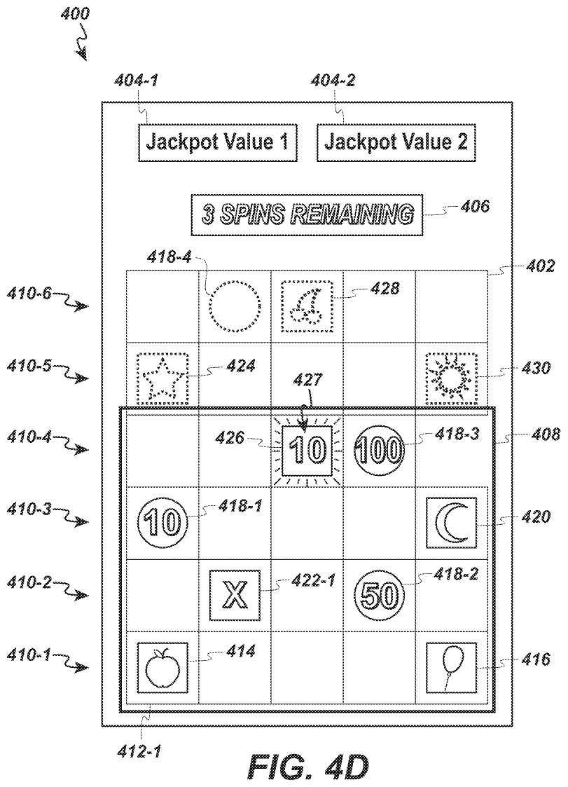

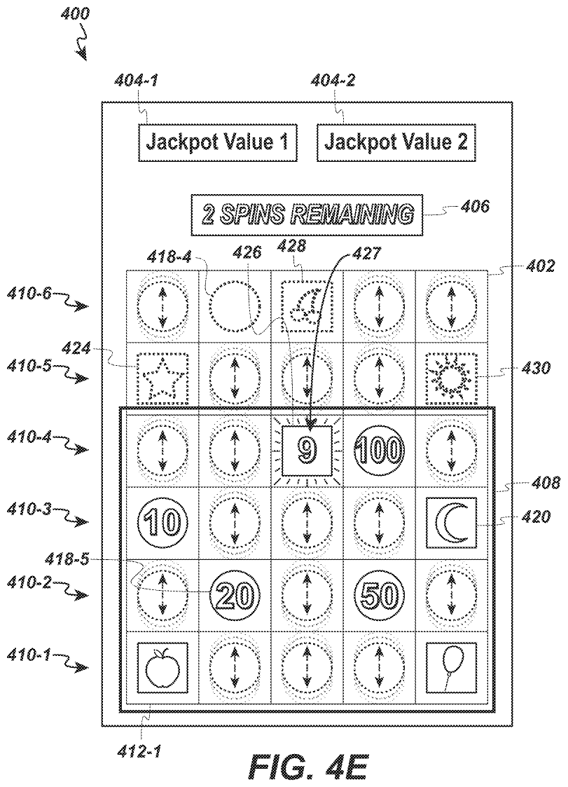

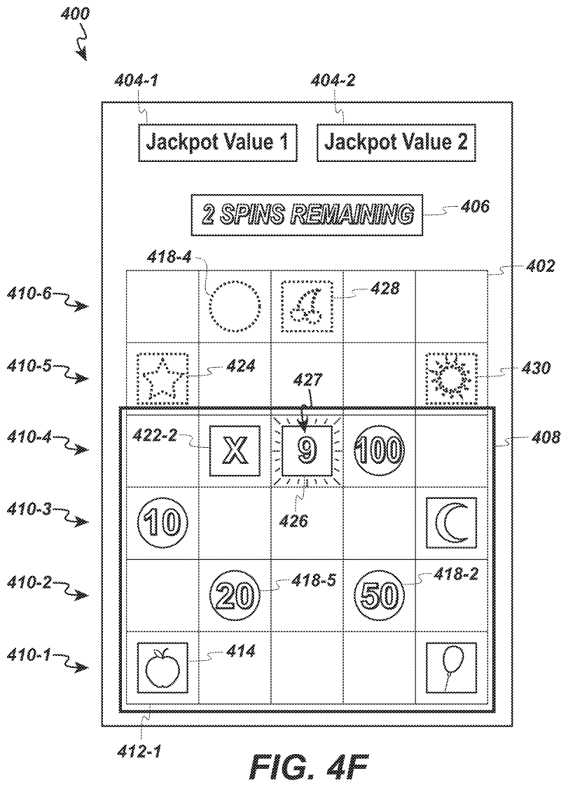

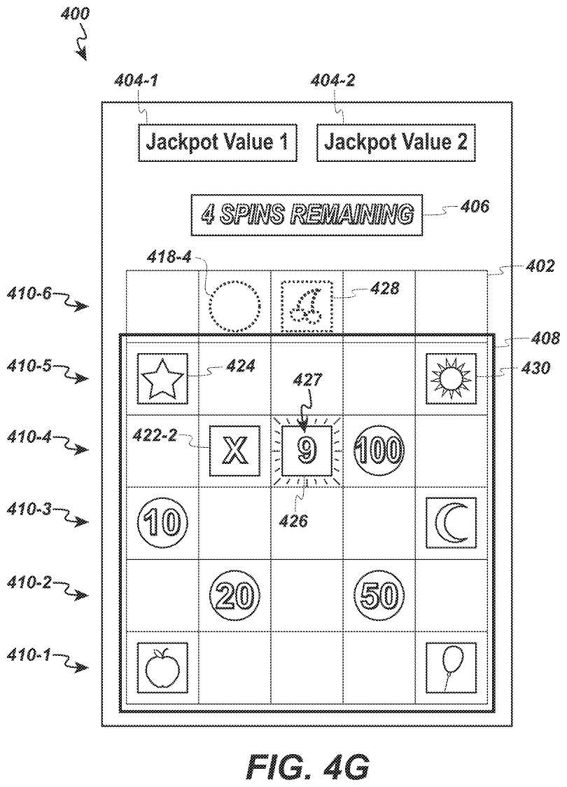

FIGS. 4A-4G illustrate an example UI 400 for a hold-and-spin style game, which may be a game instance of a main game UI or bonus game UI of a slot-type game. The UI 400 may correspond to a game play UI 304, a bonus game play UI 308, or the like, as described with respect to FIG. 3. Further, the UI elements shown and described with respect to FIGS. 4A-4G, including graphical elements depicting reel strips, award symbols, game spin counters, and the like, may correspond to game play UI elements 306 or 310, as described with respect to FIG. 3.

The UI 400 may include a symbol matrix 402, which includes symbol locations 412 (e.g., 412-1) organized in a set of rows 410 (e.g., 410-1 through 410-6) and columns. While the symbol matrix 402 includes 6 rows and 5 columns of symbol locations, this is merely one example configuration, and other matrices may also be used (e.g., 6×4, 6×6, etc.). As noted above and described herein, a particular reel strip set may be selected for the game instance from a group of predetermined reel strip sets (with each reel strip set including a plurality of reel strips). The selected reel strip set may include a row assignment for each of its reel strips, and a game processing backend system 314 may randomly populate each symbol location with a reel strip from the set of reel strips. For example, the selected reel strip set may include subsets of reel strips, with each subset being assigned to a particular row in the symbol matrix 402. When a game is initiated, the game processing backend system 314 may assign each reel strip in a subset of reel strips to a symbol location in the row to which the subset of reel strips is assigned. In some cases, such as where the UI 400 corresponds to a bonus game or supplementary game to a main game, award symbols earned during a prior spin in the main game (and which may have contributed to the bonus game being earned) may be retained for the bonus game, and may be displayed in the symbol matrix 402 prior to initiation of a spin operation during the bonus game.

When a reel spin operation is initiated, the game processing backend system 314 may determine reel outcomes for each reel strip that is available during that spin event. Available reels include reels that have not already resulted in an award being awarded to the player. The game processing backend system 314 may use an RNG to determine the reel outcome for each available reel. Reel outcomes may include, for example, a null outcome (e.g., no award is awarded), or an award outcome.

The UI 400 may also include prize indicators 404-1, 404-2, which may show one or more prizes associated with the game. The prizes may be dynamic credit values (e.g., credit values that increase or otherwise change during gameplay in response to certain game outcomes), or static credit values (e.g., each associated with a fixed credit value). In some cases, the prize indicators 404 may correspond to a major jackpot value (404-2) and a minor jackpot value (404-1). In some cases, a major jackpot may be earned if award symbols are earned in all symbol locations of the symbol matrix 402 during a game. The major jackpot may also be earned if a particular award symbol is earned (e.g., a spin-countdown award symbol), as described herein.

While two prize indicators 404 are shown, more or fewer (or none) may be included in implementations of the game. Credit values may be monetary credits, or non-monetary credits. Non-monetary credits may be redeemable for real money, or they may be “virtual gaming credits” that cannot be converted to or redeemed for real money.

The UI 400 also includes a game spin counter 406. The game spin counter 406 indicates the number of spins remaining in the game. The game spin counter 406 may have an initial value of 3 (or any other suitable value), and may be decremented by one for each spin initiated by the player. Further, a particular game outcome may reset the game spin counter 406 to the initial value. For example, if any of the reel outcomes after a spin include at least one earned symbol (e.g., a standard symbol or a special symbol), the game spin counter may reset to the initial value. If no reel outcomes include a symbol, the spin counter remains at the decremented value until the next spin. Once the game spin counter 406 reaches zero, the game ends. If the game described with respect to FIGS. 4A-4G is a bonus game, the gameplay may return to the main game.

As noted above, the game shown in FIGS. 4A-4G may start with only a subset of the rows active. Thus, the UI 400 also includes a visual indication of which rows are active and which rows are inactive. In FIGS. 4A-4G, the active rows are shown surrounded by box 408 (also referred to as the active row indicator 408), though other visual indications are also contemplated. For example, the graphical content of the active rows may differ from that of the inactive rows in color, opacity, hue, background graphics, foreground graphics, or any other suitable graphical or visible difference. For example, an earned symbol (e.g., a standard or special symbol) on an active row may have a different appearance than the same earned symbol on an inactive row (e.g., the symbol on the inactive row may have a different hue, color, opacity, or other visual effect). Where inactive rows are transitioned to active rows, the appearance of earned symbols that were displayed in the inactive row may change to provide a visual indication that those symbols are now on an active row. Further, reel spin animations in active rows may have a different visual appearance than reel spin animations in inactive rows.

FIG. 4B illustrates the UI 400 after a first spin event of the game has been initiated. The spin event may be initiated automatically after the game is initiated, or it may be initiated by the player selecting a “spin” button, pulling a handle, or otherwise providing a spin initiation input to the game. Once the spin is initiated, the game spin counter 406 is decremented to reflect that one of the 3 remaining spins in the game has been used. Additionally, spin animations 411 may be shown in each symbol location for which no symbol has yet been locked. In an initial spin condition, no symbols have been locked, so all symbol locations include spin animations 411. Further, even the inactive rows 410-4 through 410-6 spin during a spin event, and corresponding spin animations 411 are shown in the inactive rows as well as the active rows (though they may have a different appearance than the spin animations in the active rows, as described above).

During the spin animations 411, symbols on the reel strips may be temporarily visible in the symbol locations of the UI 400. For example, if the reel strip associated with symbol location 412-1 includes an award symbol, the award symbol may temporarily appear in a scrolling or spinning manner, such that the user can see the presence of the award symbol on that reel strip.

FIG. 4C illustrates the UI 400 after the spin animations have ceased, the reel outcomes have been determined (e.g., by the game processing backend system 314), and award symbols associated with the reel outcomes have been displayed in the appropriate symbol locations. As noted above, reel outcomes are displayed for the reel strips in both the active and inactive rows, and are locked in place in both the active and inactive rows (e.g., they remain in their respective symbol location throughout subsequent spins of the game). However, only the reel outcomes in the active rows are earned at the end of the spin, while the reel outcomes in an inactive row are only provisionally earned. Provisionally earned outcomes in an inactive row become earned only if the player wins an activation of that row, as described herein. As used herein, reel outcomes may correspond to award symbols. Accordingly, reel outcomes may be referred to herein as earned symbols or provisionally earned symbols.

Graphics that visually identify provisionally earned symbols may be displayed in inactive rows when the symbols are provisionally earned, such that the player can see the identity of the provisionally earned symbol. This may add to the excitement and anticipation of the gameplay, as the user can see that the award symbol has been locked-in and is one step closer to earning the associated award (e.g., a credit value). For symbols that are assigned credit values, the credit values may be assigned only after the row becomes active and the symbols become earned.

As noted above, each reel strip includes zero or more award symbols (and sometimes one or more award symbols) selected from a group of candidate award symbols. Each award symbol may be associated with a particular game outcome or otherwise have an effect on gameplay. For example, standard symbols, such as standard symbols 418, may be associated with a credit value (e.g., a monetary value or non-monetary value). The credit value may be determined by an RNG (e.g., gaming RNG 318) of the game processing backend system 314. The credit value of the standard symbols may be determined and displayed after the standard symbol is displayed. FIG. 4D shows the standard symbols 418-1 and 418-2 after their credit values have been determined and displayed. The credit value of each standard symbol earned may be added to a running total of credits that are earned during the game, which may ultimately be paid out to the user when the game ends or upon request by the user.

An award collector symbol 414, which is an example of a special symbol, is assigned a credit value based on all other credit values in the active rows of the matrix. For example, the award collector symbol 414 may be assigned a credit value of 60, based on the sum of the credit values of the standard symbols 418-1 and 418-2 (assuming no other awards were earned at the time the credit value of the award collector symbol was assigned). Award collector symbols are executed one time when they are earned, and retain the same credit value for the remainder of the game.

A persistent award collector symbol 428, which is another example of a special symbol, has the same operation as an award collector symbol, except it executes the award collection operation every spin after they are earned. For example, once the persistent award collector symbol 428 is earned, after each spin the persistent award collector symbol 428 will sum all earned awards (e.g., credit values) in the symbol matrix and add that sum to its current credit value.

An award increase symbol 416, which is another example of a special symbol, increases the credit value of one or more other awards in the active rows of the matrix. The particular awards that are increased, and the amount by which they are increased, may be determined by an RNG (e.g., gaming RNG 318) of the game processing backend system 314. As one example, the award increase symbol 416, when earned, may increase the credit value of the special symbol 418-1 from 10 to 100, and increase the credit value of the special symbol 418-2 from 50 to 70. In some cases, the particular earned awards that are to be increased may be determined by an RNG (e.g., gaming RNG 318) of the game processing backend system 314, and thereafter, the amount by which those awards are to be increased by be determined by an RNG (e.g., gaming RNG 318) of the game processing backend system 314. After an action associated with an award increase symbol 416 is performed (e.g., one or more credit values are increased), the award increase symbol 416 may convert to a standard symbol and may be assigned a credit value in the manner described above with respect to the standard symbols 418.

In some cases, the amount by which the credit values are increased may be determined using a shuffling operation without replacement. Thus, for example, credit-increase values may be included in a weighted table, and for each award symbol that is to be increased as a result of the award increase symbol 416 (as determined by an RNG, as described above), a credit-increase value may be selected. Once a credit-increase value is selected from the weighted table, that value may be removed from the table for subsequent selection operations. Thus, for example, a weighted table may include one credit-increase value of 1000 credits. If the credit-increase value of 1000 is selected and applied to a first earned award, that credit-increase value may be removed from the table or otherwise ignored for subsequent award value increases resulting from the award increase symbol. The weighted table may be reset (e.g., so all credit-increase values are available) each time an award increase symbol is earned. Shuffling the credit-increase values as described above (e.g., shuffling without replacement) may have several effects on the operation of the game function. For example, in some cases, it may be desirable or necessary to limit the maximum payout of the game feature, such as in jurisdictions with maximum payout limits. In such cases, shuffling without replacement can help limit the maximum payout that a player can win. As another example, shuffling the credit-increase values without replacement can help manage the RTP of the game function and prevent or mitigate uncontrolled payouts.

A persistent award increase symbol 424, which is another example of a special symbol, has the same operation as an award increase symbol, except it executes the award increase operation every spin after they are earned. For example, once the persistent award increase symbol 424 is earned, after each spin the persistent award increase symbol 424 will increase the credit value of one or more other awards in the active rows of the matrix. The particular awards that are increased, and the amount by which they are increased, may be determined by an RNG (e.g., gaming RNG 318) of the game processing backend system 314. In some cases, the credit-increase values for each execution of the persistent award increase symbol 424 are determined using a shuffling operation without replacement, as described with respect to the award increase symbol 416. In some cases, the weighted table may be reset, such that all potential credit-increase values are included in the table, after each spin and/or each time a persistent award increase symbol 424 is executed.

An award value multiplier symbol 420 applies a multiplier to earned credit values (e.g., all earned credit values or a subset of earned credit values). The multiplier may be fixed within the game, such that all award value multiplier symbols in the game (e.g., for all game instances) have the same multiplier value. In other cases, the multiplier may be determined when earned, such as by an RNG (e.g., gaming RNG 318) of the game processing backend system 314. The multiplier may be a 2× multiplier, 3× multiplier, 4× multiplier, or any other suitable multiplier value. As one example, the award value multiplier symbol 420, when earned, may apply a 2× multiplier to the credit value of the standard symbol 418-1 (increasing it from 10 to 20) and to the credit value of the standard symbol 418-2 (increasing it from 50 to 100). After an action associated with an award value multiplier symbol 420 is performed (e.g., one or more credit values are multiplied by a multiplier), the award value multiplier symbol 420 may convert to a standard symbol and may be assigned a credit value in the manner described above with respect to the standard symbols 418.

A spin count increase symbol 430, which is another example of a special symbol, increases the value to which the game spin counter resets when certain game outcomes are met. For example, as described above, the game spin counter may reset to an initial value of three when a player earns any symbol on a spin. If the player earns the spin count increase symbol 430, the game spin counter may instead reset to a value of four when a player earns any symbol on a spin. After the spin count increase symbol 430 changes the game spin counter's reset value, the spin count increase symbol 430 may convert to a standard symbol and may be assigned a credit value in the manner described above with respect to the standard symbols 418.

A spin-countdown award symbol 426, which is another example of a special symbol, includes an award spin counter 427 that is decremented each time a new spin is initiated after the spin-countdown award symbol is earned. If the award spin counter 427 reaches zero, the spin-countdown award symbol is assigned a credit value. In some cases, the assigned credit value corresponds to a jackpot value (e.g., a minor jackpot value 404-1 or a major jackpot value 404-2). In some cases, the assigned credit value is selected from a set of potential credit values that includes both a major jackpot (e.g., jackpot value 2, 404-2) or a minor jackpot (jackpot value 1, 404-1). In such cases, whether the major or minor jackpot (or other credit value) is awarded is determined by an RNG (e.g., gaming RNG 318).

In some cases, the assigned credit value of a spin-countdown award symbol 426 corresponds to a predetermined credit value other than a jackpot value. The assigned credit value may be determined by an RNG (e.g., gaming RNG 318) of the game processing backend system 314.

The initial value of the award spin counter 427 (e.g., the number of spins that must occur in order to earn a credit value from the spin-countdown award symbol 426) may be a fixed value (e.g., all award spin counters of the game have the same initial value), or it may vary (e.g., an RNG of the game processing backend system 314 may select an initial value from a candidate range of values each time a spin-countdown award symbol is earned).

A row activation symbol 422, which is another example of a special symbol, increases the number of active rows in the game. For example, if a row activation symbol is earned, the number of active rows may be increased by one. When an inactive row becomes active in response to a player earning a row activation symbol, any reel outcomes that had been provisionally earned in the inactive row become earned, and their award dynamics (if any) are executed. For example, if a standard award was provisionally earned, when the row on which it was earned becomes active, a credit value may be assigned to the standard award as described above. As another example, if an award increase symbol was provisionally earned, when the row on which it was earned becomes active, the credit value of one or more earned awards may be increased, as described above.

As described above, the activation of inactive rows, as well as the assignment of particular reel strips to particular rows, provides a high degree of control over game factors such as RTP, volatility, and progressivity of awards. For example, the likelihood of earning an award on a reel strip in the highest row is based on the particular parameters of that reel strip (e.g., the symbols and symbol weighting), as well as the likelihood of activating each of the lower initially-inactive rows. Due to the cumulative effect of these different probabilities, more and more varied special award symbols may be provided in a given game, and thus more unique and varied game outcomes may be provided, while still effectively managing factors such as RTP, volatility, and progressivity, and mitigating the risk uncontrolled payouts.

FIG. 4C illustrates each of the foregoing symbols having been earned (in the active rows 410-1 through 410-3) or provisionally earned (e.g., in the inactive rows 410-4 through 410-6) on the first spin. This particular set of earned and/or provisionally earned symbols is merely for illustrative purposes, and other reel outcomes are also possible, including reel outcomes in which no symbols are earned or provisionally earned.

FIG. 4C illustrates an example game outcome after the reel spins for the first spin are complete. Once the reel spins are complete (including the reel spin animations having ceased), the earned symbols are displayed in their respective symbol locations, and any actions associated with the symbols are performed. Actions associated with the symbols include assigning credit values to the symbols, changing already earned credit values, increasing the number of active rows, or any other action described herein with respect to symbols. In some cases, the actions associated with the earned symbols are performed in a predetermined order. For example, if a row activation symbol is earned, the additional row may be activated before other symbol actions are performed.

FIG. 4D illustrates the UI 400 after at least some of the actions associated with the earned symbols have been performed. For example, because the player earned at least one symbol, the game spin counter 406 has been reset to the initial value (e.g., 3 spins). Also, the row activation symbol 422-1 was earned, resulting in the active row indicator 408 expanding to indicate that row 410-4 is now active, and the symbols that were provisionally earned on that row (e.g., the spin-countdown award symbol 426 and the standard symbol 418-3) are now earned. Credit values are also assigned to the standard symbols 418 based on the outcomes from an RNG, as described above. Further, the actions of the other earned symbols 414, 416, and 420 may also be performed (and any associated graphical outputs such as animations, images, characters, videos, etc. may be displayed). For example, the award collector symbol 414 may be assigned the credit value of the sum of all other earned awards, the award value multiplier symbol 420 may cause all other earned credit values to be multiplied (e.g., doubled), and the award increase symbol 416 may cause some or all of the other earned credit values to be increased. Details of the actions associated with these symbols are described above.

At some point before the next spin, the row activation symbol 422-1 may be converted to a standard symbol and given a credit value (e.g., based on an RNG, as described above). FIG. 4D shows the row activation symbol 422-1 before being converted to a standard symbol. FIG. 4E shows UI 400 after the row activation symbol 422-1 has been converted to a standard symbol 418-5 with a credit value of 20. While FIG. 4D shows the row activation symbol 422-1 before being converted to the standard symbol, the conversion may occur before the subsequent spin is initiated.

In some cases, the actions associated with the earned award symbols are performed (e.g., executed) in a particular order. One example order of execution is: row activation symbols; spin count increase symbols; standard symbols; award increase symbols; persistent award increase symbols; award multiplier symbols; award collector symbols; persistent award collector symbols; and spin-countdown award symbols. In another example order of execution, the persistent award increase symbols are executed prior to the award increase symbols, and the persistent award collector symbols are executed prior to the award collector symbols. Other orders of execution are also possible. In some cases, the particular order of execution may be established so as to effectively manage or balance game characteristics such as RTP. For example, by executing award multiplier symbols before award collector and persistent award collector symbols, certain exponential award results may be avoided or limited. More particularly, multiplier symbols may operate on already-awarded credit values, including the credit values of accumulator awards (e.g., award collector symbols whose values are the sum of all or some already-awarded credit values). Accordingly, executing the multiplier symbols before executing the accumulator awards may result in a significantly different numerical outcome (e.g., a lower overall prize) than executing the multiplier symbols after the accumulator awards. In this way, the particular order of execution of symbols may be used to manage the RTP of the game and/or predict or limit the maximum payout amounts. While the foregoing example illustrates some potential effects of changing the order of two example symbols, it will be understood that any of the symbols described herein may be executed in a different order than the example above in order to achieve a target RTP or other game metric.

In some cases, the order of execution may be dynamically determined using random and/or pseudorandom selection operations. For example, the entire order of execution may be dynamically determined after each spin. As another example, a subset of the award symbols may be subject to a selection operation to determine a relative order of execution. As a particular example of the latter case, the order of execution of the award increase symbols and the award collector symbols may be determined dynamically (e.g., to determine whether the award increase symbols are executed before or after the award collector symbols are executed). Any suitable amount of the award symbols may be subject to a dynamic order-of-execution selection operation (e.g., between two of the award symbols and all of the award symbols).

As described herein, award symbols may include graphical outputs, such as animations, that are displayed when the award symbols are earned. These graphical outputs may be performed in conjunction with the award actions associated with the award symbols. Thus, as one nonlimiting example, when an award increase symbol is executed, the award increase symbol may be animated (e.g., showing a graphic moving from the award increase symbol towards other award symbols), and the award symbols that are increased by the award increase symbol may also be animated (e.g., growing in size temporarily). Other award symbol may be associated with other types of animations. In some cases, animations are not shown for award symbols when they are provisionally earned (e.g., in an inactive row). Such animations may be shown, however, when provisionally earned award symbols are earned (e.g., when an inactive row with provisionally earned award symbols becomes active).

After the actions associated with earned symbols have been performed (e.g., according to a particular order of performance, such as the one described above), a subsequent spin may be initiated. The subsequent spin may be initiated without user input, such as after a certain time has elapsed after the last action associated with an earned symbol has been performed, and/or a last graphical output has been displayed. Alternatively or additionally, the subsequent spin may be initiated by a user, such as by pulling a lever, pressing a physical or virtual button, or the like. FIG. 4E illustrates the UI 400 after the subsequent spin has been initiated.

In response to initiation of the subsequent spin, the game spin counter 406 is decremented by one to reflect the use of one of the remaining spins. Additionally, the award spin counter 427 of the spin-countdown award symbol 426 is decremented by one. In this example, the award spin counter 427 is decremented from ten to nine, showing the user that the award associated with the spin-countdown award symbol 426 will be earned if nine more spins are initiated. As there are only two spins remaining in the game spin counter 406, the spin-countdown award can only be earned if the player earns additional spins, such as by earning any award symbol on a spin (which resets the game spin counter 406 to the initial value or another earned value). If the player does earn additional spins and the award spin counter 427 reaches zero, a prize associated with the spin-countdown award symbol 426 is awarded to the player. If the prize is awarded when there are additional spins remaining, the prize may be awarded to the player when the award spin counter 427 reaches zero, and the spin-countdown award symbol 426 may remain in its symbol location for subsequent spins. In some cases, the spin-countdown award symbol 426 may display the amount of the prize that was earned as a result of the spin-countdown award symbol 426.

In response to initiation of the subsequent spin, spin animations are shown in each symbol location 412 that does not already have an award symbol locked or held therein. FIG. 4F illustrates an example game outcome after the reel spins for the subsequent spin are complete. Once the reel spins are complete (including the reel spin animations having ceased), the earned symbols are displayed in their respective symbol locations, and any actions associated with the symbols are performed. For example, FIG. 4F illustrates a row activation symbol 422-2 earned in row 410-4.

FIG. 4G illustrates the UI 400 after at least some of the actions associated with the earned symbols from the subsequent spin have been performed. For example, because the row activation symbol 422-2 was earned, the active row indicator 408 expands to indicate that row 410-5 is now active, and the symbols that were provisionally earned on that row (e.g., the persistent award increase symbol 424 and the spin count increase symbol 430) are now earned. As noted above, the active row indicator 408 may correspond to any graphical object or graphical or visual effect that visually differentiates active rows from inactive rows.

Actions associated with the earned awards are then performed. For example, as noted above, the persistent award increase symbol 424 may increase the credit value of one or more other awards in the active rows of the matrix. The particular awards that are increased, and the amount by which they are increased, may be determined by an RNG, as described above.

Additionally, because the player earned at least one symbol during the spin (the row-activation symbol 422-2), the game spin counter 406 would reset to its initial value of three spins. In this case, however, the player has also earned the spin count increase symbol 430, which increases the number of spins to which the game spin counter resets when a spin results in at least one award symbol being earned. Thus, as shown in FIG. 4G, the game spin counter 406 has reset to four spins instead of the initial value of three spins. Once the spin count increase symbol 430 has been earned, each spin in which a new award symbol is earned (e.g., a standard symbol or special symbol) in any one of the symbol locations, the game spin counter 406 resets to 4 spins.

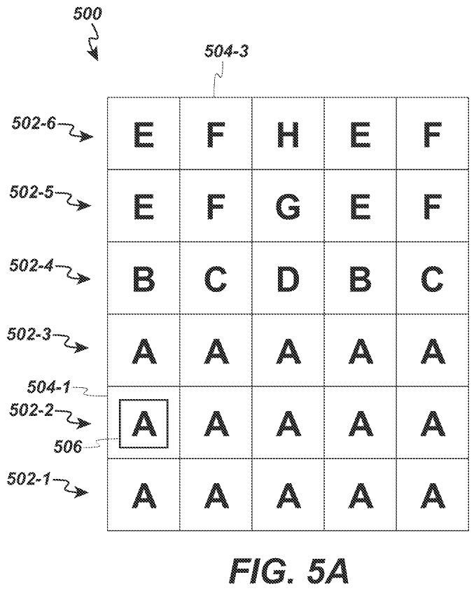

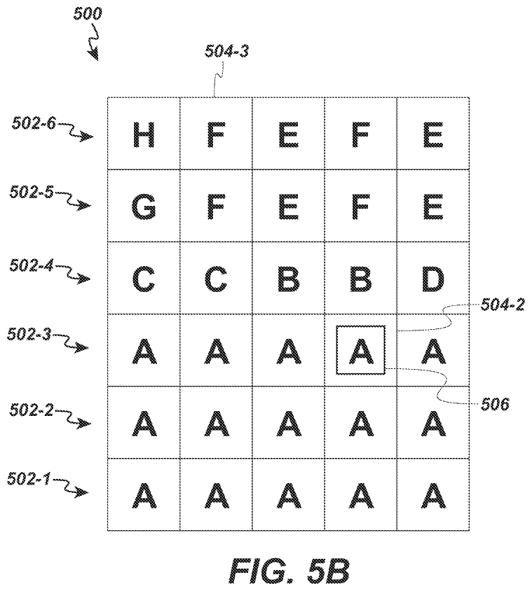

As noted above, the gameplay described with respect to FIGS. 4A-4G may be facilitated by selecting a specific set of reel strips from a set of predefined reel strip sets, and assigning each of the reel strips to a symbol location in a matrix of symbol locations. FIGS. 5A-5B illustrate an example assignment of reel strips from a set of reel strips to symbol locations in a symbol matrix 500.

The set of reel strips used in the example of FIGS. 5A-5B is selected from a group of predetermined reel strip sets. Each predetermined reel strip set includes multiple reel strips, and each reel strip has a predetermined set of symbols. For the purposes of FIGS. 5A-5B, reel strips having the same sets of symbols are identified by the same letter. Thus, for example, the “A” reel strips may all have the same sets of symbols thereon, which may be different from the sets of symbols on the “B” reels (and so forth). The predetermined sets of reel strips may be specifically configured to achieve particular game results, such as to implement a new gaming device operation that uses dynamic symbols to increase credit-values of earned symbols, while also maintaining a certain RTP and game volatility. Accordingly, there may be a limited number of predetermined sets of reel strips available for the gaming system to choose from when a game is initiated. Further, each predetermined set of reel strips may be associated with a potential payout value. In particular, each reel strip may have one or more symbols, each associated with an award value or potential award value. Some reel strips may have symbols that have a higher potential payout than others. For example, award value multipliers and award collectors may have a higher potential payout value than standard symbols, as they can act on multiple already-earned standard symbols and thus have a greater impact on the game outcome (e.g., the credits awarded) than a single standard symbol. Accordingly, the particular reel strips in each set of reel strips (and the particular symbols on each reel strip) may be selected so that the set of reel strips includes a combination of potential payout values that results in particular RTP and game volatility characteristics.

FIGS. 5A-5B illustrate one example predetermined reel set, which may have a specification of “AAAAA AAAAA AAAAA BCDBC EFGEF EFHEF.” A limited number of additional predefined specifications, each associated with and/or defining a predetermined reel strip set, may therefore be provided. As one nonlimiting example, another reel set specification may be “AAAAA AAAAA AAAAA BDDCC EGGEF EEHEE.” In some cases, all of the predetermined reel strip sets have the same reel strip specifications for the first three rows of the symbol matrix.

The reel strips in a predetermined set of reel strips may be weighted reel strips. In such cases, each reel strip of a particular designation (e.g., “A,” “B,” etc.) has the same symbols in the same reel strip positions, but have different weightings. Thus, for example, a first “A” reel strip may have a different weighting than another “A” reel strip, a first “F” reel strip may have a different weighting than a second “F” reel strip, and so forth.

In response to a game feature being triggered and/or when a first spin event is initiated, each reel in each predetermined set of reel strips is assigned to a specific row in the symbol matrix. Thus, for example, in the predetermined reel set shown in FIGS. 5A-5B, each symbol location in rows 502-1 through 502-3 has an “A” reel assigned thereto, while row 502-4 is assigned to a subset of reels including “BCDBC,” row 502-5 is assigned to a subset of reels including “EFGEF,” and row 502-6 is assigned to a subset of reels including “EFHEF.” After assigning the reel strips to a specific row, a spin event may be initiated (e.g., by a user pulling a lever, pressing a physical or virtual button, or the like). In response to detecting the initiation of the spin event, the positions of the reel strips in the symbol matrix may be randomly assigned. Thus, while row 502-4 has the reel strip order “BCDBC,” this is merely one example ordering of the reel strips in that row when this particular set of reel strips is randomly assigned to the symbol locations. In another game instance in which this reel set is selected, the randomization or shuffling of the reel strips in response to the initiation of the spin event, the order may be “BDBCC,” for example. After the spin event is initiated (and the reel strips are randomly assigned to the symbol locations), reel outcomes for each reel strip may be determined and displayed in the symbol matrix.

While the position of the reel strips within a row may be randomly assigned after spin events are initiated (or at least may differ between instances where the predefined set of reel strips is used), each reel strip is specific to (e.g., assigned to) a specific row. By assigning the reel strips to a particular row, the RTP, volatility, and/or other game play parameters may be managed. For example, symbols with higher potential payout values (e.g., persistent award collectors, spin-countdown award symbols) may be positioned on higher rows, which are initially inactive. In this way, the RTP of the game can be more accurately predicted and managed, thereby ensuring exciting gameplay while also complying with regulatory requirements.

As noted above, the reel strips may be reassigned to different symbol locations in the symbol matrix (within their initially assigned rows) with each spin. Thus, for example, while FIG. 5A illustrates a first example reel strip assignment for a first spin (which may be the initial spin of the game or a later spin), FIG. 5B illustrates a second example reel strip assignment for a subsequent spin. In particular, after the reel outcomes for the reel strips as shown in FIG. 5A are determined, a user may initiate a subsequent spin event (e.g., by pulling a lever, pressing a physical or virtual button, or the like). In response to the initiation of the subsequent spin event, the reel strips may be reassigned within the symbol matrix, as shown in FIG. 5B.

As noted above, each reel strip is assigned to a row in the matrix, so when the reel strips are shuffled, they are only moved among the row to which they are assigned. Thus, for example, the reel strip assignment in row 502-6 in FIG. 5A (for a first spin) is “EFHEF,” while in FIG. 5B (for a second spin), the reel strip assignment is “HFEFE.” In the case where a symbol is earned or provisionally earned on a spin, that reel strip becomes locked in that position in the symbol matrix, while the remaining reel strips are re-assigned to the remaining symbol locations in the row (e.g., using an RNG as described above). Thus, for example, if in the first spin a symbol was earned in symbol location 504-3, then the “F” reel (and the earned or provisionally earned award symbol in that symbol location) would remain in the same position during the reel-strip reassignment operation before the next spin, while the remaining reel strips would be re-assigned to the other symbol locations in the row 502-6, resulting in the order shown in FIG. 5B, for example.

During each spin for which at least one row remains inactive, a reel strip on one of the active rows may be replaced with a row-activation reel strip 506. The row-activation reel strip 506 may include one or more row-activation symbols 422, and may be the only reel strip in a game that includes row-activation symbols 422. The particular symbol location to which the row-activation reel strip is assigned may be determined by an RNG, as described above. For example, FIG. 5A shows that the row-activation reel strip 506 has been assigned to symbol location 504-1 (and may therefore take the place of the “A” reel strip that was otherwise at that location), while FIG. 5B shows the row-activation reel strip 506 at the different symbol location 504-2. In this way, only one row-activation symbol can be earned during each spin, and the symbol location where the row-activation symbol may be earned may change at each spin. In some cases, the game is configured so that the row-activation reel strip only replaces one type of reel strip (e.g., the “A” reel strips), or only appears in a limited number of rows (e.g., rows 502-1 through 502-3). In other cases the row-activation reel strip may replace other types of reel strips and/or appear in any row (except the top row). Further, the game may include multiple row-activation reel strips, each associated with a different number and/or location of row-activation symbols, and/or a different weighting. The particular row-activation reel strip used for each spin may be determined by an RNG, as described above.

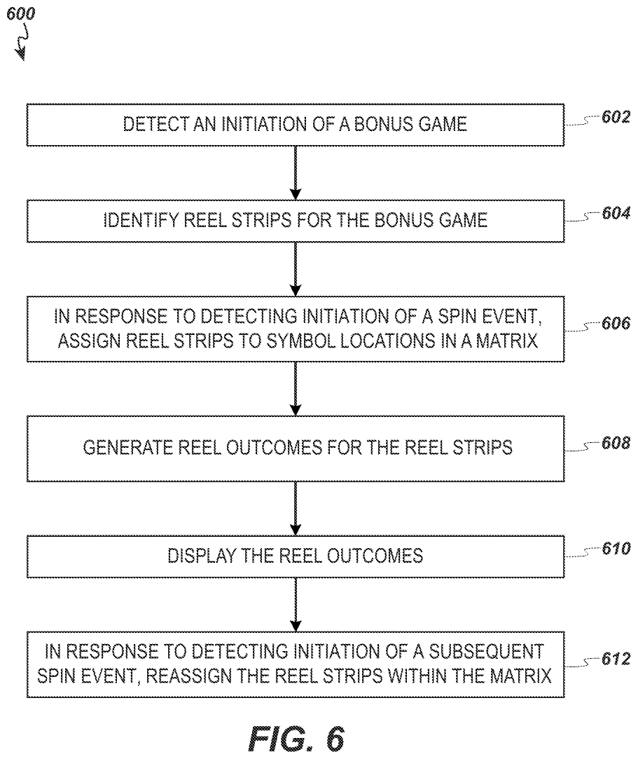

FIG. 6 is a sample flowchart 600 showing an example method for assigning reel strips to locations in a symbol matrix to generate random based game outcomes with special symbols, while also managing game characteristics such as RTP and/or volatility of the game, as described herein. Generally, the flowchart 600 illustrates a set of operations that may result in the game play or game functions shown and described with respect to FIGS. 4A-5B.

At operation 602, a gaming system (and/or a processor of a gaming system) may detect an initiation of a bonus game. A bonus game may be initiated as a result of a main game of a gaming system awarding a player the bonus game. For example, reel outcomes of a main game may result in the bonus game being awarded to the player. In some cases, a bonus game may be initiated as a result of a player purchasing or otherwise selecting to play the bonus game. The gaming system may detect such events indicating that the bonus game is to be initiated.

At operation 604, in response to detecting the initiation of the bonus game, the gaming system may identify reel strips for the bonus game. Identifying the reel strips may include identifying a first plurality of reel strips for an initially active first row of symbol locations in a symbol matrix of the gaming system, and identifying a second plurality of reel strips for an initially inactive second row of symbol locations in the symbol matrix. The second plurality of reel strips may be associated with a greater potential payout value than the first plurality of reel strips, and therefore their assignment to the initially inactive row may help manage RTP and volatility of the game while providing gameplay features using special award symbols. Examples of identifying reel strips for initially active and initially inactive rows in the symbol matrix, including the positioning of reel strips having different potential payout values in different rows, are described herein with respect to FIGS. 5A-5B, for example.

At operation 606, in response to a spin event (e.g., initiated by a user pulling a lever or otherwise selecting a spin initiation input), the gaming system randomly assigns reel strips to symbol locations in a symbol matrix. For example, the gaming system may assign each respective reel strip of the first plurality of reel strips to a respective symbol location in the first row of symbol locations, including randomly assigning a first reel strip to a first symbol location in the first row of symbol locations and assigning a second reel strip to a second symbol location in the first row of symbol locations. The gaming system may also randomly assign each respective reel strip of the second plurality of reel strips to a respective symbol location in the second row of symbol locations, including randomly assigning a third reel strip to a third symbol location in the second row of symbol locations and assigning a fourth reel strip to a fourth symbol location in the second row of symbol locations. As described, by assigning reel strips from the first plurality of reel strips to the first row of symbol locations (e.g., an initially active row) and reel strips from the second plurality of reel strips to the second row of symbol locations (e.g., an initially inactive row), the RTP and volatility of the game can be effectively managed. By randomly assigning reel strips to different symbol locations in the same row, symbols on the reel strips may appear in different places in the symbol matrix (therefore providing dynamic gameplay effects) without affecting the RTP or volatility of the overall game.

At operation 608, the gaming system generates reel outcomes for the reel strips, including reel outcomes for reel strips on active rows of the symbol matrix and for reel strips on inactive rows of the symbol matrix. Reel outcomes may be determined by an RNG, along with weighted tables associated with each reel strip, as described above. Although FIG. 6 illustrates that operation 608 occurs after operation 606, other implementations of flowchart 600 could implement operation 606 after operation 608 or simultaneously.

At operation 610, the gaming system displays reel outcomes. For example, the reel outcome for each reel strip is displayed in its assigned symbol location of the symbol matrix. Credit values for certain reel outcomes may also be assigned. Thus, for example, if a reel outcome corresponds to standard symbol, a credit value may be assigned to that symbol. As another example, if a reel outcome corresponds to a special symbol (e.g., an award collector symbol, or another special symbol described herein), a credit value may be assigned to that symbol (or to other affected symbols).

At operation 612, in response to detecting an initiation of a subsequent spin event (or otherwise prior to determining and/or displaying reel outcomes for a subsequent spin), the gaming system may reassign the reel strips within the symbol matrix. Reassigning the reel strips may include assigning at least two reel strips of the second plurality of reel strips to different symbol locations in the second row of symbol locations, and optionally assigning at least two reel strips of the first plurality of reel strips to different symbol locations in the first row of symbol locations.

In some cases, each reel strip that has not been locked after a spin event (e.g., each reel strip whose reel outcome was not an award symbol) is necessarily assigned to a different symbol location in the symbol matrix for the subsequent spin. The particular symbol location that each unlocked reel strip is assigned to may be determined by an RNG, as described above. This reassignment scheme may be referred to as a forced-reassignment scheme.

In other cases, each reel strip that has not been locked after a spin event may be, but is not required to be, assigned to a different symbol location in the symbol matrix for the subsequent spin. In such cases, whether a reel strip is assigned to a different symbol location (and if so, which symbol location) may be determined by an RNG, as described above. Thus, any given reel strip that is subject to reassignment at the outset of a spin event may either remain in the same symbol location, or be reassigned to a new symbol location, depending on the outcome of the RNG or other selection algorithm. This may be referred to as an unforced-reassignment scheme.

In some cases, only a subset of the reel strips are subject to reassignment at the outset of a spin event. For example, the reel strips on the initially inactive rows may be subject to reassignment on subsequent spins, while the reel strips on the initially active rows may remain in their initially assigned locations. In such cases, the reel strips that are subject to reassignment may be reassigned according to a forced-reassignment scheme, or an unforced-reassignment scheme. Further, different reel strips may be subject to different reassignment schemes. For example, the reel strips on the initially inactive rows may be subject to a forced-reassignment scheme, while the reel strips on the initially active rows may be subject to an unforced-reassignment scheme. Other combinations are also contemplated.

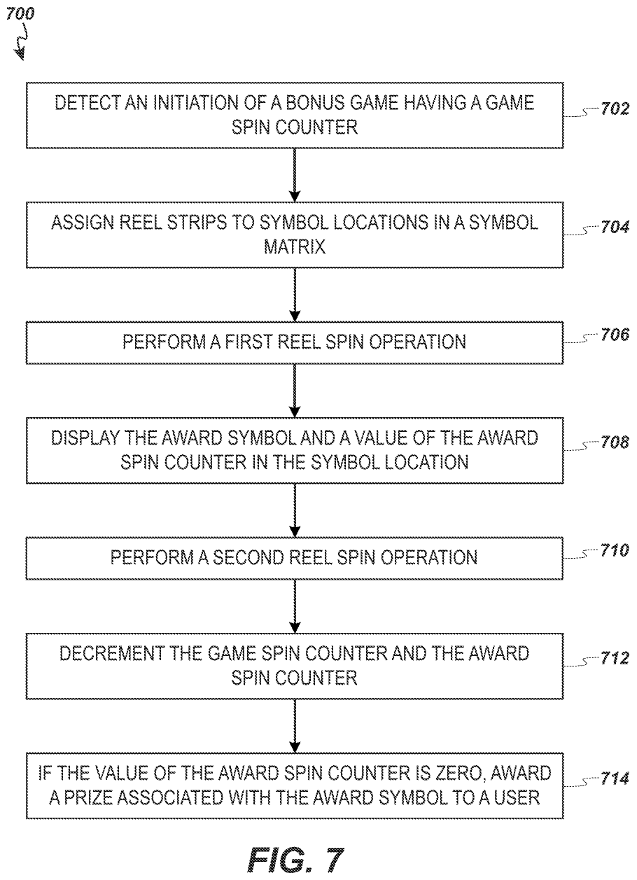

FIG. 7 is a sample flowchart 700 showing another example method for assigning reel strips to locations in a symbol matrix to generate random based game outcomes with special symbols, while also managing game characteristics such as RTP and/or volatility, as described herein. Generally, the flowchart 700 illustrates a set of operations that may result in the game play or game functions shown and described with respect to FIGS. 4A-5B.

At operation 702, a gaming system (and/or a processor of a gaming system) may detect an initiation of a bonus game that includes a game spin counter. A bonus game may be initiated as a result of a main game of a gaming system awarding a player the bonus game. For example, reel outcomes of a main game may result in the bonus game being awarded to the player. In some cases, a bonus game may be initiated as a result of a player purchasing or otherwise selecting to play the bonus game. The gaming system may detect such events indicating that the bonus game is to be initiated. The game spin counter may indicate a number of remaining spins in the bonus game, where each spin event decrements the game spin counter by one and at least one reel outcome resets the game spin counter to an initial value. An example game employing a game spin counter is described with respect to FIGS. 4A-4G.

At operation 704, the gaming system assigns reel strips to symbol locations in a symbol matrix. For example, the gaming system may assign a first reel strip of a first plurality of reel strips to a first symbol location of an initially active row of symbol locations, and assign a second reel strip of a second plurality of reel strips to a second symbol location of an initially inactive row of symbol locations. The first plurality of reel strips may be associated with a first potential payout value, and the second plurality of reel strips associated with a second potential payout value greater than the first potential payout value. Further, at least one of the first reel strip or the second reel strip may include an award symbol associated with an award spin counter. The award spin counter may have an initial value that is higher than the initial value of the game spin counter, as described with respect to FIGS. 4C-4E. In some cases, the symbol associated with the award spin counter is on the second reel strip, and as such is assigned to an initially inactive row of symbol locations. In some cases, the symbol associated with the award spin counter is only assigned to a row in the symbol matrix that is initially inactive. As described above, the RTP and volatility of the game can be effectively managed at least in part by assigning reel strips having higher potential payout values, such as an award spin counter, to initially inactive rows.

At operation 706, the gaming system performs a first reel spin operation. Performing the first reel spin operation may include determining reel outcomes for each reel using an RNG, along with weighted tables associated with each reel strip, as described above.

At operation 708, accordance with a determination that a reel outcome of the first reel spin operation for at least one of the first reel strip or the second reel strip corresponds to the award symbol associated with the award spin counter, the gaming system displays the award symbol and a value of the award spin counter. As described above, the value of the award spin counter may be a fixed value (e.g., 10), or it may be selected using an RNG.

At operation 710, the gaming system performs a second reel spin operation, which may include determining second reel outcomes for each reel using an RNG, along with weighted tables associated with each reel strip, as described above.

At operation 712, the gaming system decrements the game spin counter and the award spin counter by one. Decrementing the award and game spin counters is described herein with respect to FIGS. 4D-4E.

At operation 714, if, after decrementing the award and game spin counters, the award spin counter is zero, the gaming system may award a prize associated with the award symbol. If, after decrementing the award and game spin counters, the game spin counter is zero and the award spin counter is not zero, the gaming system may terminate the bonus game. As described herein, certain game outcomes may result in the game spin counter increasing and/or resetting to an initial value. Accordingly, the likelihood of earning the prize associated with the award spin counter may be based, at least in part, on the reel strip assignments within the symbol matrix and which reel strips are assigned to initially inactive or active rows. Accordingly, game characteristics such as the RTP and volatility of the game, may be managed by assigning reel strips to particular rows in a symbol matrix at the initiation of the bonus game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A gaming system comprising one or more processors and memory, the memory storing data defining one or more reel strip sets and further storing computer-executable instructions which, when executed, cause the one or more processors to perform operations comprising:
detecting an initiation of a game instance;
in response to detecting the initiation of the game instance:
identifying a first plurality of reel strips for an initially active first row of symbol locations in a symbol matrix of the gaming system and a second plurality of reel strips for an initially inactive second row of symbol locations in the symbol matrix, the second plurality of reel strips associated with a greater potential payout value than the first plurality of reel strips; and
assigning each respective reel strip of the first plurality of reel strips to a respective symbol location in the first row of symbol locations, the assigning including:
assigning a first reel strip to a first symbol location in the first row of symbol locations; and
assigning a second reel strip to a second symbol location in the first row of symbol locations;
assigning each respective reel strip of the second plurality of reel strips to a respective symbol location in the second row of symbol locations, the assigning including:
assigning a third reel strip to a third symbol location in the second row of symbol locations; and
assigning a fourth reel strip to a fourth symbol location in the second row of symbol locations; and
in response to an initiation of a spin event:
generating a respective reel outcome for each respective reel strip of the first and second pluralities of reel strips.

2. The gaming system of claim 1, wherein:
the third reel strip has a first set of symbols; and
the fourth reel strip has a second set of symbols that is different from the first set of symbols.

3. The gaming system of claim 1, further comprising:
displaying the respective reel outcome for each respective reel strip of the first and second pluralities of reel strips; and
in response to an initiation of a subsequent spin event, assigning at least two reel strips of the second plurality of reel strips to different symbol locations in the second row of symbol locations, including assigning the third reel strip to a fifth symbol location different from the third symbol location.

4. The gaming system of claim 3, wherein the respective reel outcomes for the third and fourth reel strips are not associated with award symbols.

5. The gaming system of claim 1, wherein:
the method further comprises displaying the respective reel outcome for each respective reel strip of the first and second pluralities of reel strips; and
a first one of the displayed reel outcomes corresponds to a first symbol displayed in the initially active first row of the symbol matrix; and
a second one of the displayed reel outcomes corresponds to a second symbol displayed in the initially inactive second row of the symbol matrix.

6. The gaming system of claim 5, wherein:
the spin event is a first spin event;
the respective reel outcome for each respective reel strip is a first respective reel outcome; and
the instructions further cause the one or more processors to perform the operation of, after the spin event and prior to the initiation of a second spin event, assigning a credit value to the first symbol.

7. The gaming system of claim 6, wherein:
the credit value is a first credit value; and
the instructions further cause the one or more processors to perform the operations of:
detecting the initiation of the second spin event;
in response to detecting the initiation of the second spin event, generating a second respective reel outcome for each respective reel strip of the first and second pluralities of reel strips;
displaying the second respective reel outcome for each respective reel strip of the first and second pluralities of reel strips; and
in accordance with a determination that a reel outcome of the second spin event corresponds to a row activation symbol:
activating the initially inactive second row of the symbol matrix; and
assigning a second credit value to the second symbol.

8. A gaming system comprising one or more processors and memory, the memory storing data defining one or more reel strip sets and further storing computer-executable instructions which, when executed, cause the one or more processors to perform operations comprising:
detecting an initiation of a game instance;
in response to detecting the initiation of the game instance:
selecting a reel strip set from among a group of predetermined reel strip sets, the reel strip set defining:
a first subset of reel strips assigned to a first row of a symbol matrix of the gaming system, at least one reel strip of the first subset of reel strips including a first symbol associated with an award; and
a second subset of reel strips assigned to a second row of the symbol matrix of the gaming system, at least one reel strip of the second subset of reel strips including a second symbol associated with an award value multiplier;
populating the first row of the symbol matrix of the gaming system with reel strips from the first subset of reel strips; and
populating the second row of the symbol matrix of the gaming system with reel strips from the second subset of reel strips, wherein
the first row is an initially active row of the game instance; and
the second row is an initially inactive row of the game instance.

9. The gaming system of claim 8, wherein the instructions further cause the one or more processors to perform the operations of, in response to an initiation of a spin event:
generating a respective reel outcome for each reel strip of the first subset of reel strips;
displaying the respective reel outcome for each respective reel strip of the first subset of reel strips;
generating a respective reel outcome for each reel strip of the second subset of reel strips; and
displaying the respective reel outcome for each respective reel strip of the second subset of reel strips.

10. The gaming system of claim 9, wherein:
populating the first row of the symbol matrix with reel strips from the first subset of reel strips comprises assigning a first reel strip from the first subset of reel strips to a first symbol location in the first row of the symbol matrix; and
the instructions further cause the one or more processors to perform the operations of, in response an initiation of a subsequent spin event, assigning the first reel strip from the first subset of reel strips to a second symbol location in the first row of the symbol matrix, the second symbol location different from the first symbol location.

11. The gaming system of claim 8, wherein the instructions further cause the one or more processors to perform the operation of replacing a reel strip in the first subset of reel strips with a row-activation reel strip.

12. The gaming system of claim 11, wherein the instructions further cause the one or more processors to perform the operations of, in response to an initiation of a spin event:
generating a respective reel outcome for each reel strip of the first subset of reel strips, the first subset of reel strips including the row-activation reel strip;
displaying the respective reel outcome for each respective reel strip of the first subset of reel strips;
generating a respective reel outcome for each reel strip of the second subset of reel strips; and
displaying the respective reel outcome for each respective reel strip of the second subset of reel strips.

13. The gaming system of claim 12, wherein the instructions further cause the one or more processors to perform the operation of, in accordance with a determination that a reel outcome for a reel strip of the second subset of reel strips is the second symbol, displaying the second symbol in the initially inactive row.

14. The gaming system of claim 13, wherein the instructions further cause the one or more processors to perform the operation of, in accordance with a determination that the reel outcome of the row-activation reel strip corresponds to a row activation symbol, transitioning the initially inactive row to an additional active row.

15. The gaming system of claim 14, wherein the instructions further cause the one or more processors to perform the operation of, after transitioning the initially inactive row to the additional active row, performing an action associated with the second symbol, the action including increasing a credit value of an award displayed in the initially active row or the additional active row.

16. A method of conducting a slot game at a gaming system, comprising:
detecting an initiation of a game instance having a game spin counter indicating a number of remaining spins in the game instance, wherein each spin event decrements the game spin counter by one and at least one reel outcome resets the game spin counter to an initial value;
in response to detecting the initiation of the game instance:
assigning a first reel strip of a first plurality of reel strips to a first symbol location of an initially active row of symbol locations, the first plurality of reel strips associated with a first potential payout value; and
assigning a second reel strip of a second plurality of reel strips to a second symbol location of an initially inactive row of symbol locations, the second plurality of reel strips associated with a second potential payout value greater than the first potential payout value, wherein at least one of the first reel strip or the second reel strip includes an award symbol associated with an award spin counter having an initial value that is higher than the initial value of the game spin counter;
performing a first reel spin operation;
in accordance with a determination that a reel outcome of the first reel spin operation for at least one of the first reel strip or the second reel strip corresponds to the award symbol, displaying the award symbol and a value of the award spin counter;
performing a second reel spin operation;
in response to performing the second reel spin operation:
decrementing the game spin counter by one and decrementing the award spin counter by one; and
in accordance with a determination that the value of the award spin counter is zero, awarding a prize associated with the award symbol to a user.

17. The method of claim 16, wherein awarding the prize comprises:
selecting a credit value from a set of candidate credit values; and
awarding the selected credit value to the user.

18. The method of claim 17, further comprising, in response to performing the second reel spin operation, in accordance with a determination that the value of the award spin counter is not zero and that a value of the game spin counter is not zero, allowing the user to initiate a third reel spin operation.

19. The method of claim 18, further comprising:
performing the third reel spin operation; and
in response to performing the third reel spin operation:
decrementing the game spin counter by one and decrementing the award spin counter by one; and
in accordance with a determination that the value of the award spin counter is zero, awarding the prize associated with the award symbol to the user.

20. The method of claim 16, wherein the second reel strip assigned to the initially inactive row of symbol locations includes the award symbol associated with the award spin counter.
